(19) United States
(12) Patent Application Publication
(10) Pub. No.: US 2026/0205722 A1
(43) Pub. Date: Jul. 16, 2026

(54) DATA COLLECTION SYSTEM

(71) Applicant: NTT, Inc., Tokyo (JP)

(72) Inventors: Shinya TAMAKI, Tokyo (JP); Tomohiro TANIGUCHI, Tokyo (JP); Ryota SHIINA, Tokyo (JP)

(73) Assignee: NTT, Inc., Tokyo (JP)

(21) Appl. No.: 19/135,907

(22) PCT Filed: Dec. 8, 2022
(86) PCT No.: PCT/JP2022/045221

§ 371 Date: Jun. 5, 2025

(51) Int. Cl. H04Q 9/00; H04L 69/168

(52) U.S. Cl. CPC H04Q 9/00; H04L 69/168

(57) ABSTRACT

An object of the present disclosure is to enable a plurality of sensor terminals to cooperate when an event occurs.

The present disclosure is a data collection system that collects sensing data detected by a sub-sensor terminal and a main sensor terminal having different sensing targets in the management node, in which the sub-sensor terminal transmits an event occurrence notification using an extension area of a layer 2 communication protocol when sensing a sensing target of the own apparatus, the management node transmits an instruction according to the event occurrence notification to the main sensor terminal when receiving the event occurrence notification from the sub-sensor terminal, and the main sensor terminal executes an operation defined by the instruction in response to reception of the instruction from the management node.

### TECHNICAL FIELD

The present disclosure relates to collection of sensing data in the Internet of things (IoT).

### BACKGROUND ART

Network configuration information and device information about a terminal and a device are acquired with a lightweight communication protocol that is standardized and does not require high performance. For example, Non Patent Literature 1 reports a method using a link layer discovery protocol ((LLDP), see, for example, Non Patent Literature 3).

In IoT, it is necessary to network a large number of sensor terminals and collect data (sensing data) generated by the sensor terminals. In addition, in data utilization in IoT, importance of not only sensing data itself generated by a sensor terminal but also data related to sensing data called metadata has been reported (Non Patent Literature 2 and the like), and it is expected that a user can safely and easily utilize the sensing data by acquiring and distributing the sensing data and the metadata together. For example, when the LDP disclosed in Non Patent Literature 1 is used, metadata (device information) such as a manufacturer name and a model number related to sensing data can be collected with an economical system configuration.

### CITATION LIST

### Non Patent Literature

Non Patent Literature 1: Yoshiyuki Mihara, Takefumi Yamazaki, Manabu Okamoto, Atsushi Sato, “Designing HTIP which Identifies Home Network Topology and Applying HTIP to a Troubleshooting Application”, Journal of the Information Processing Society of Japan, Consumer Device & System, Vol. 2, No. 3, pp. 34-45, Dec. 2012.
Non Patent Literature 2: Toshihiko Oda, Hiroshi Imai, Takeshi Naito, Hajime Takebayashi, “An Approach of Defining, Generating and Utilizing Metadata for Sensing Data Trading Market”, 2018 National Convention of the Society of Artificial Intelligence (32 times), June 2012.
Non Patent Literature 3: IEEE Std 802.1AB-2016, “IEEE Standard for Local and metropolitan area networks—Station and Media Access Control Connectivity Discovery”
Non Patent Literature 4: IEEE Std 802.11TM-2016 P.708 (Probe Request), P.712 (Probe Response)

### SUMMARY OF INVENTION

### Technical Problem

A camera that is activated from a sleep state and starts imaging when an object such as a person approaches is used. As described above, when the sensing data can be acquired in response to the occurrence of an event, the power consumption of the sensor terminal can be suppressed. When a plurality of sensor terminals related to an event that has occurred starts operating in response to the occurrence of the event, more information related to the event can be acquired.

Therefore, an object of the present disclosure is to enable a plurality of sensor terminals to cooperate when an event occurs.

### Solution to Problem

The present disclosure is a data collection system. that collects, in a management node, sensing data detected by a sub-sensor terminal and a main sensor terminal that have different sensing targets. When sensing the sensing target of the own apparatus, the sub-sensor terminal transmits an event occurrence notification using an extension area of a layer 2 communication protocol. The main sensor terminal executes an operation defined by an instruction from the management node.

The management node executes a data collection method of the present disclosure. Specifically, when receiving an event occurrence notification indicating that the sensing target is sensed by the sub-sensor terminal by using the extension area of the layer 2 communication protocol, the management node gives an instruction according to the event occurrence notification to the main sensor terminal.

The operation defined by the instruction may be start of sensing by the main sensor terminal. In this case, when receiving the instruction, the main sensor terminal may be activated from a sleep state.

The main sensor terminal may be a camera terminal that captures an image. In this case, the operation defined by the instruction may be attachment of a marker to captured video data.

In addition, the sensing target by the sub-sensor terminal includes approach of an object including a person or a thing. In this case, the sub-sensor terminal senses that an object including a person or a thing approaches the vicinity of the own apparatus. The sub-sensor terminal transmits an event occurrence notification in response to the sensing.

Note that the above inventions can be combined in any possible manner.

### Advantageous Effects of Invention

The present disclosure can enable a plurality of sensor terminals to cooperate when an event occurs.

### BRIEF DESCRIPTION OF DRAWINGS

FIG. 1 is a diagram describing a data collection system according to the present disclosure.

FIG. 2 is a diagram describing a terminal of the data collection system according to the present disclosure.

FIG. 3 is a diagram describing a management node of the data collection system according to the present disclosure.

FIG. 4 is a diagram describing a frame transmitted from a terminal to a management node.

FIG. 5 illustrates an arrangement example of terminals.

FIG. 6 is a diagram describing a data collection system according to the present disclosure.

FIG. 7 is a diagram describing a data collection system according to the present disclosure.

### DESCRIPTION OF EMBODIMENTS

Embodiments of the present invention will be described with reference to the accompanying drawings. The embodiments to be described below are examples of the present invention, and the present invention is not limited to the embodiments to be described below. Note that components having the same reference numerals in the present description and the drawings indicate the same components.

### First Embodiment

In the present embodiment, a basic configuration of a data collection system will be described.

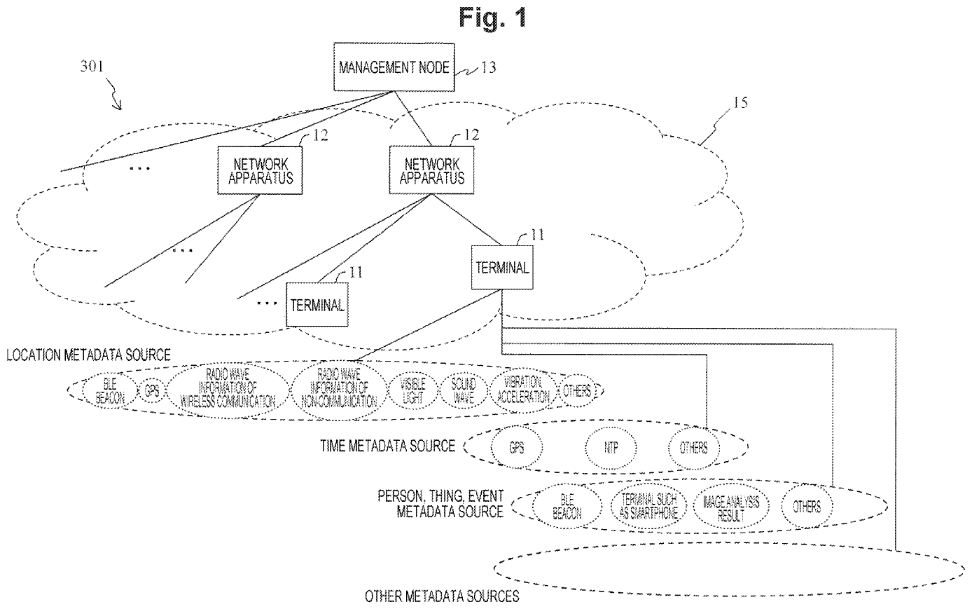

FIG. 1 is a diagram describing a data collection system 301 of the present embodiment. The data collection system 301 is a data collection system that performs communication from a terminal 11 to a network apparatus 12 by using an extension area of a standardized communication protocol (LLDP, HTTP, IEEE 802.11, or the like), in which

the terminal 11 stores sensing data detected by a sensor device in an area different from an area for storing metadata in a frame defined by the communication protocol, and sends the frame to the network apparatus 12,

the network apparatus 12 transfers the frame to a management node 13, and

the management node 13 stores the sensing data and the metadata in association with each other on the basis of information for identifying the terminal 11 described in the frame.

A data collection network 15 is a network that connects the terminal 11 existing in a specific range and the management node 13. The data collection network 15 is, for example, a local area network (LAN), a field area network (FAN), or an IoT area network. In the same data collection network 15, there may be a plurality of terminals 11 of a single type, or there may be terminals 11 of a plurality of types.

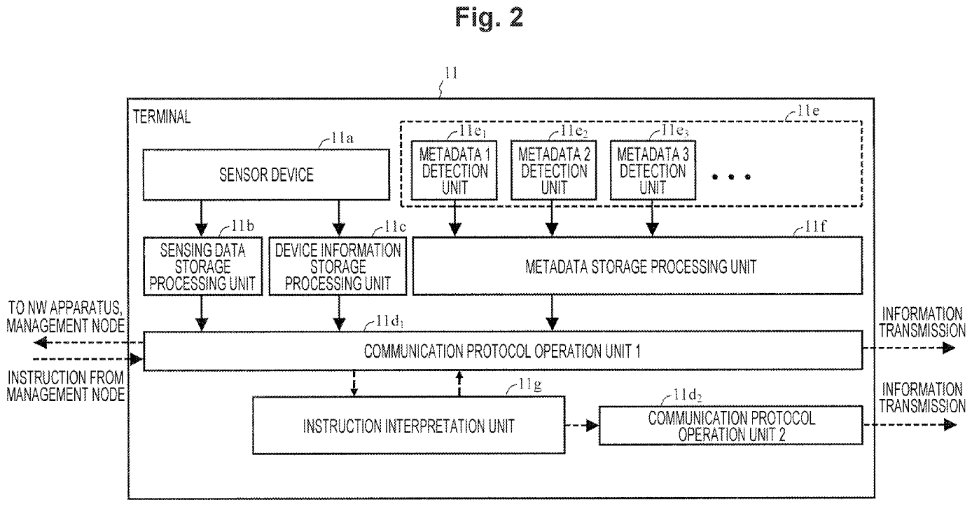

FIG. 2 is a diagram describing the terminal 11,

The terminal 11 is, for example, an IoT sensor terminal, performs sensing regarding an object to be observed, and generates sensing data. The terminal 11 includes a sensor device 11a, a sensing data storage processing unit 11b, a device information storage processing unit 11c, a communication protocol operation unit 11di, metadata detection units (11e₁, 11e₂, 11e₃, . . . ), and a metadata storage processing unit 11f.

The sensor device 11a performs sensing regarding an object to be observed and acquires sensing data (main data). The sensing data is, for example, temperature, image, acceleration, sound, light, CO2, or the like.

The device information storage processing unit 11c collects device information of the object to be observed (for example, a manufacturer name, a model name, a model number, or the like of the device) and stores the information at a predetermined position of a frame (area that can be used for unique applications, such as an “extension area” or an “optional area” defined by the protocol).

The sensing data storage processing unit 11b stores the sensing data from the sensor device 11a at a predetermined position of a frame (such as a payload portion defined by protocol). The sensing data storage processing unit 11b may convert the sensing data into a certain shortened code and store the shortened code, or divide the sensing data into a plurality of frames and store (fragment) the frames so as to conform to the form/restriction of the unique extension area of the frame, and store the processed sensing data in the frame.

The sensing data storage processing unit 11b can arbitrarily set a storage timing at which the sensing data is stored in the frame. For example, the storage timing may be set such that the sensing data is stored every time when the sensing data is updated, or the sensing data may be stored not sequentially but at a timing at which the sensing data is accumulated for a certain period of time. In addition, in a case where the sensing data is accumulated for a certain period of time, the sensing data storage processing unit 11b may store a record (log) thereof or a result of specific calculation/statistical processing in the frame.

The type and storage timing of the sensing data to be stored in the frame may be fixed or vary. The type and storage timing of the sensing data may be dynamically changed according to determination by the terminal 11 itself and an instruction from the management node 13.

In addition, a transmission cycle of the frame may also be fixed or vary. The transmission cycle of the frame may be dynamically changed according to determination by the terminal 11 itself and an instruction from the management node 13.

The metadata detection unit 11e acquires information other than the device information (metadata). The information other than the device information is, for example, position information, time information, person, thing, or event information, and other information of the detection target. However, the present invention does not limit the information other than the device information to these pieces of information. In order to acquire these pieces of information, the metadata detection unit 11e includes a position information detection unit 11e₁, a time detection unit 11e₂, a person, thing, event detection unit 11e₃, and other detection units.

The position information detection unit 11e₁ is, for example, a GPS, an acceleration sensor, a gyro sensor, or an RSSI receiver such as a Wi-Fi signal or a Bluetooth low energy (BLE) beacon signal, Then, location metadata detected by the position information detection unit 11e₁ is a GPS signal, a BLE beacon signal, radio wave information of wireless communication, radio wave information of non-communication (television, radio, radio clock, other noise, or the like), power information, visible light information, sound wave information, vibration information, acceleration information, and information regarding a position acquired from another location metadata source.

The time detection unit 11e₂ is, for example, an information receiver from a GPS or a network time protocol (NTP). Then, time metadata detected by the time detection unit 11e₂ is a GPS signal, information from an NTP, and information regarding a time acquired from another time metadata source.

The person, thing, event detection unit 11e₃ is a receiver that receives information from a BLE beacon (carried by a person) or a smartphone carried by a person or information from an image analysis result, for example. Person, thing, or event metadata detected by the person, thing, event detection unit 11e₃ is a BLE beacon carried by a person, information from a smartphone carried by a person, information from an image analysis result, or information regarding a person, thing, or event acquired from another current event metadata source.

Examples of the metadata detected by the other detection units include information regarding a network configuration of the data collection network 15.

Note that the metadata detection unit 11e may detect all of a plurality of detection targets or may detect any one of the detection targets.

The metadata storage processing unit 11f stores the data detected by the metadata detection unit 11e as metadata in an extension area or an optional area in a frame set by the communication protocol. For example, the metadata storage processing unit 11f can store the metadata in a control-system frame of the IEEE 804.11 wireless LAN. Specifically, various metadata are stored in a “Vendor Specific” area, which is an extension area of a Probe Request frame. Alternatively, various metadata are stored in a “Vendor Specific” area, which is an extension area of a Probe Response frame.

The metadata storage processing unit 11f may convert the metadata into a certain shortened code and store the shortened code, or divide the metadata into a plurality of frames and store (fragment) the frames so as to conform to the form/restriction of the unique extension area of the frame, and store the processed metadata in the frame.

The metadata storage processing unit 11f can arbitrarily set a storage timing at which the metadata is stored in the frame. For example, the storage timing may be set such that the metadata is stored every time when the metadata is updated, or the metadata may be stored not sequentially but at a timing at which the metadata is accumulated for a certain period of time. In addition, in a case where the metadata is accumulated for a certain period of time, the metadata storage processing unit 11f may store a record (log) thereof or a result of specific calculation/statistical processing in the frame.

The type and storage timing of the metadata to be stored in the frame may be fixed or vary. The type and storage timing of the metadata may be dynamically changed according to determination by the terminal 11 itself and an instruction from the management node 13.

The communication protocol operation unit 11d₁ transmits a frame in which the sensing data and the device information are stored in a predetermined area and the metadata is stored in the extension area of the optional area to the network apparatus 12 using a lightweight and standardized communication protocol such as LLDP or home network topology identifying protocol (HTIP). Note that the communication protocol of the frame in which the sensing data is stored and the communication protocol of the frame in which the device information is stored may be the same or different. In the latter case, the metadata storage processing unit 11f may store the metadata in the frame of any one of the communication protocols (the frame in which the sensing data is stored or the frame in which the device information is stored), or may store the metadata in the frames of both communication protocols (the frame in which the sensing data is stored and the frame in which the device information is stored).

Further, the terminal 11 also has a function of operating in accordance with an instruction from the management node 13 or the like. Specifically, the terminal 11 includes an instruction interpretation unit 11g, and performs information transmission, in a case where the BLE beacon signal or the metadata information (information to be transmitted, radio wave intensity, sending frequency, and the like) transmitted by the terminal itself is changed, on information to the outside according to the instruction from the management node 13. In a case where information transmission is performed using the same protocol as in the communication with the network apparatus 12, the communication protocol operation unit 11d₁ is operated. In a case where information transmission is performed using a protocol different from that in the communication with the network apparatus 12, a communication protocol operation unit 11d₂ is provided in addition to the communication protocol operation unit 11d₁, and the communication protocol operation unit 11d₂ is operated.

Note that a case where the terminal 11 itself is beacon signal source for another terminal to grasp metadata is also included. For example, the terminal 11 may be a beacon signal source for identifying location metadata, or may be a beacon terminal carried by an operator to identify an approaching person.

The network apparatus 12 is, for example, an apparatus such as a network switch, a wireless access point, or a wireless repeater. The network apparatus 12 sends a frame group uploaded from a lower data collection network 15 to the management node 13 as it is.

Here, the network apparatus 12 may include a processing part for the metadata included in the terminal 11 (the metadata detection unit 11e and the metadata storage processing unit 11f). Even in a case where the network apparatus 12 does not include the sensor device 11a, the network apparatus 12 can additionally attach unique information such as its own MAC address and metadata such as a connection port to the frame transmitted from the terminal 11 and transfer the frame to the management node 13.

When the network apparatus 12 includes the processing part for the metadata, the logical connection from the management node 13 to the terminal 11 can be grasped, and a more accurate logical/physical network management map can be created.

That is, even when the network apparatus 12 is a network switch (switching hub), a wireless repeater, or the like that does not have layer 3 or higher functions, since the present technology is performed in layer 2, it is possible to manage/grasp connection of network devices including the network apparatus 12.

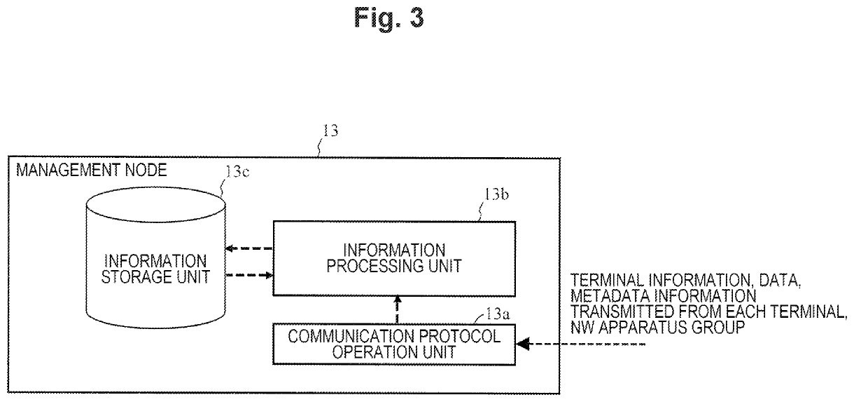

FIG. 3 is a diagram describing the management node 13. The management node 13 includes a communication protocol operation unit 13a, an information processing unit 13b, and an information storage unit 13c. The management node 13 extracts information from the frame passed from the network apparatus 12, stores the information, and uses the information for analysis. In particular, the management node 13 is characterized by having a function of storing a combination of two or more pieces of collected information in the information storage unit 13c.

The communication protocol operation unit 138 receives a frame in which the sensing data or the metadata from the terminal 11 or the network apparatus 12 is stored. The information processing unit 13b extracts the sensing data, the device information, and the metadata described below from the received frame, and organizes these in the information storage unit 13c on the basis of information for identifying the individual terminal 11 (for example, MAC address).
(1) Physical information of the terminal (information such as characteristics of a housing, image information, information on an attached label, a target pointed by the operator's finger, and a target of the operator's line of sight)
(2) Identifier of the terminal on a logical network (MAC address, UUID, or the like)
(3) Main data (sensing data such as temperature, image, acceleration, sound, light, or CO2).
(4) Various metadata (data such as location, time, person, thing, or event)

For example, the management node 13 refers to metadata regarding location, and stores main data acquired at the same location or in a certain area in the format of [location metadata, main data].

### Supplement

The location metadata will be supplemented.

Like GPS information, there is a case where metadata is direct location metadata at the time point of sensing by the terminal 11. On the other hand, at the time point when a signal, visible light, or sound information from a BLE beacon is sensed by the terminal 11 and sent as metadata, whether or not it is location information is not determined, and the management node 13 may recognize/grasp the metadata as location metadata.

### End of Supplement

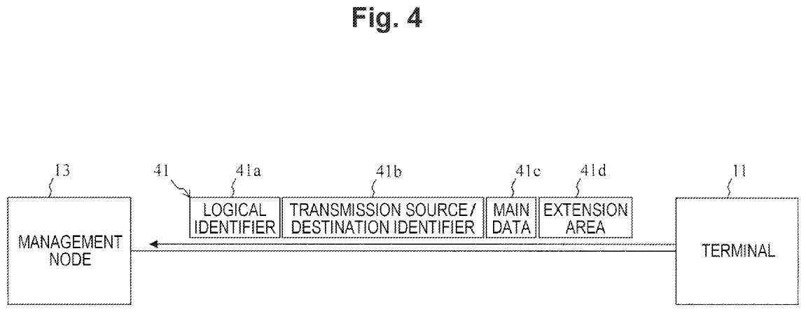

FIG. 4 is a diagram describing a frame 41 transmitted from the terminal 11 to the management node 13. In FIG. 4, description of the network apparatus 12 is omitted. The frame 41 is a layer 2 communication frame such as an Ethernet (registered trademark) frame or a Wi-Fi communication frame. The frame 41 includes a logical identifier 41a of a communication device such as a MAC address, an identifier 41b of a transmission source or destination such as an IP address, an area 41c in which sensing data such as temperature or an image is stored, and an extension area 41d in which metadata is stored. Among these, the identifier 41b and the area 41c are layer 3 communication packets.

For example, the management node 13 combines the MAC address of the logical identifier 41a, and the location metadata of the extension area 41d to associate them as [MAC address, location metadata], and combines the MAC address of the logical identifier 418 and installer metadata of the extension area 41d to associate them as [MAC address, installer metadata], and organize them in the information storage unit 13c.

As described above, the data collection system 301 can acquire the network configuration information, the device information, the sensing data, and the metadata of the terminal and the device using a communication protocol that does not require high performance.

### Second Embodiment

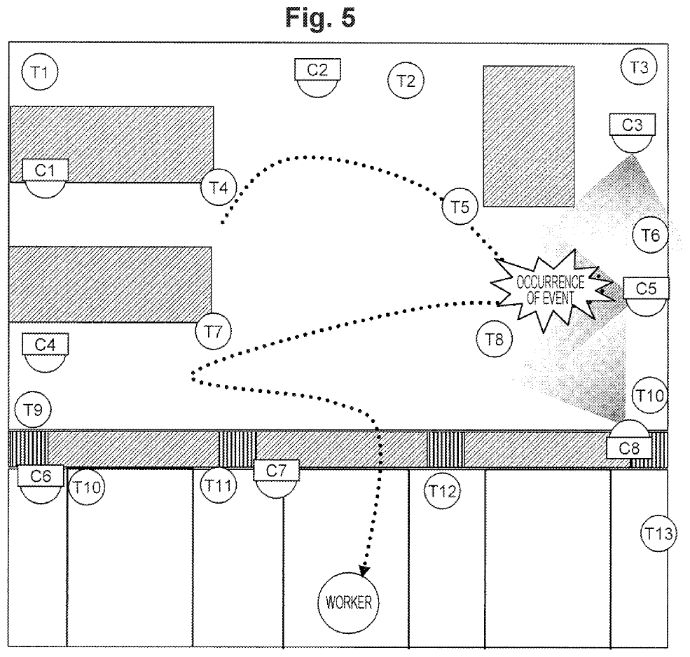

FIG. 5 illustrates an arrangement example of terminals. A system of the present embodiment includes camera terminals C1 to C8 that function as terminals 11 and capture images, and human sensor terminals T1 to T13 that sense the approach of a person. As described above, the present disclosure includes the terminals 11 of different sensor types. In the present embodiment, the camera terminals C1 to C8 function as main sensor terminals, and the human sensor terminals T1 to T13 function as sub-sensor terminals. The camera terminals C1 to C8 and the human sensor terminals T1 to T13 are sensor terminals with limited resources to be, for example, battery-driven.

For example, in a work space such as an office or a warehouse, a worker acts in the warehouse after wearing a lightweight apparatus (battery-driven small terminals such as BLE beacons, smartphones, and smartwatches). At this time, the human sensor terminals T1 to T13 sense the position and state (moving, stopping) of the worker, and the camera terminals C1 to C8 capture an image of the worker.

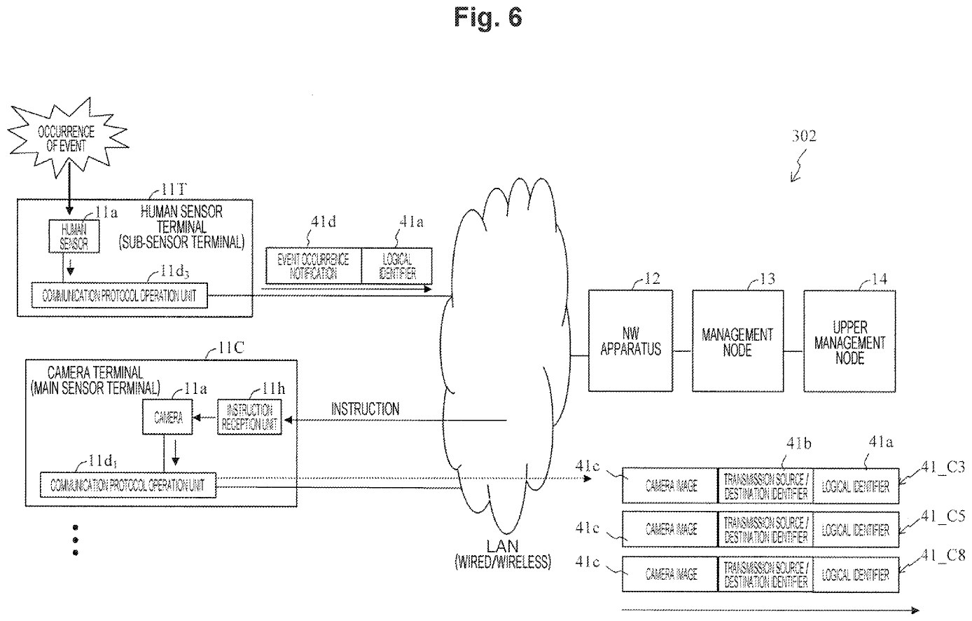

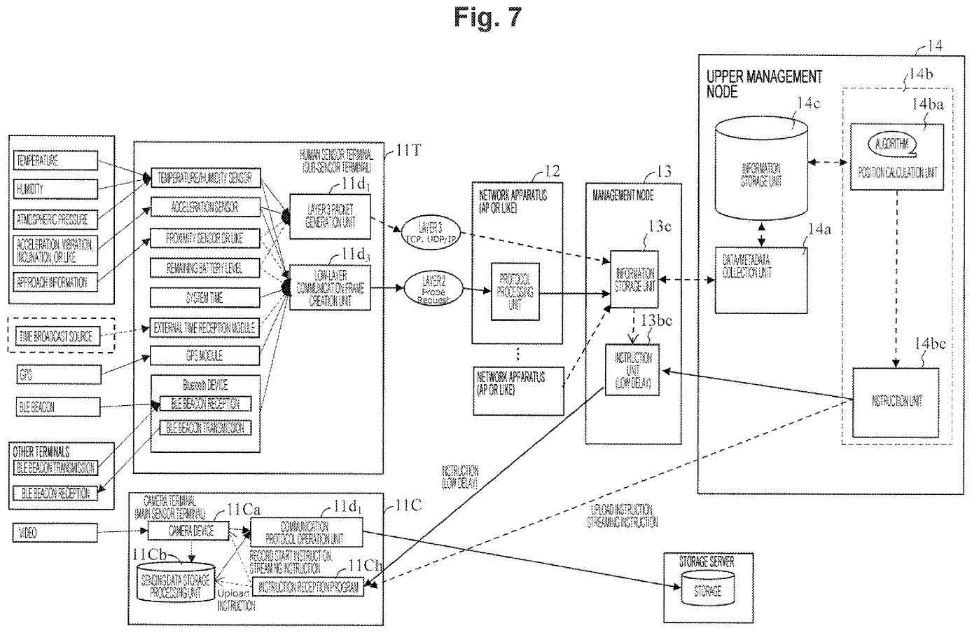

FIGS. 6 and 7 are diagrams describing a data collection system 302 of the present embodiment. In the present embodiment, an example is described in which the sensor terminals are a human sensor terminal 11T and a camera terminal 11C. The sensor device 11a included in the human sensor terminal 11T is any sensor capable of sensing a person, and is, for example, an infrared detection apparatus. The sensor device 11a included in the camera terminal 11C is a camera device.

FIGS. 6 and 7 illustrate an example in which an upper management node 14 is connected to an upper level of the management node 13. The upper management node 14 includes a data/metadata collection unit 14a that collects various types of information stored in the management node 13, an information processing unit 14b that executes processing of various types of information collected by the data/metadata collection unit 14a, and an information storage unit 14c. In this figure, an example is described in which the information processing unit 14b includes a position information calculation unit 14ba that calculates the positions of the human sensor terminal 11T and the camera terminal 11C, and an instruction unit 14bc that gives an instruction to the management node 13 and the sensor terminal 11.

The human sensor terminal 11T, which is a sub-sensor terminal, is activated from sleep when sensing an event that is a sensing target of the own apparatus. The human sensor terminal 11T immediately sends an event occurrence notification immediately after activation from sleep. At this time, the human sensor terminal 11T stores the event occurrence notification in the extension area of the layer 2 communication frame. For example, a human sensor terminal T8 illustrated in FIG. 5 stores an event occurrence notification indicating that a person is sensed in the extension area of the layer 2 communication frame, and transmits the frame to the management node 13. In the present embodiment, the event occurrence notification can be performed with a low delay by using the layer 2 communication frame.

Upon receiving the event occurrence notification from the human sensor terminal T8, the management node 13 gives an instruction to the camera terminal 11C associated with the human sensor terminal T8. For example, camera terminals C3, C5, and C8 that are close to the human sensor terminal T8 in location metadata can be exemplified. The camera terminals C3, C5, and C8 can be selected in advance for each human sensor terminal 11T in the position information calculation unit 14ba. The management node 13 acquires in advance from the instruction unit 14bc that the camera terminal 11C near the human sensor terminal T8 is the camera terminals C3, C5, and C8, and instructs the camera terminals C3, C5, and C8 based on this acquired information. As a result, no instruction is issued to the other unrelated camera terminal 11C, and the camera terminal 11C is caused to sleep when unnecessary, so that the power consumption of the camera terminal 11C can be saved.

Upon receiving the instruction from the management node 13, the camera terminal 11C is activated from sleep and starts imaging. In the present embodiment, since a low-delay instruction is received, it is possible to start imaging quickly. Thus, detailed analysis can be performed later, and the data value is improved.

The camera terminal 11C transmits video data obtained by imaging to the management node 13. At this time, the management node 13 of the present embodiment can acquire video data from the camera terminals C3, C5, and C8 illustrated in FIG. 5. Thus, the value of the data is improved by accumulating the video data from multiple angles at which the imaging is quickly started.

Here, the timing at which the camera terminal 11C transmits the video data may be in real time, but the present disclosure is not limited thereto. For example, the camera terminal 11C may transmit the captured video data to at least one of the management node 13 and the upper management node 14 when receiving an upload instruction or a streaming instruction from the upper management node 14 connected to the upper level of the management node 13.

The camera terminal 11C corresponding to the human sensor terminal 11T may be stored in advance in the information storage unit 13c, but the present disclosure is not limited thereto. For example, the human sensor terminal T8 may store the location where the human sensor terminal T8 has sensed a person in the extension area 41d of the layer 2 communication frame together with the event occurrence notification as the location metadata. In this case, in the upper management node 14, the position information calculation unit 14ba selects the camera terminal 11C according to the location metadata, and the instruction unit 14bc instructs the corresponding camera terminal 11C. By adopting such a configuration, even when the sub-sensor terminal such as the human sensor terminal 11T moves, an instruction can be given to an appropriate main sensor terminal.

As described above, in the present embodiment, the detection result of the human sensor terminal 11T is used as an imaging start trigger of the camera terminal 11C. As a result, the video of the worker can always be captured from multiple angles. Here, in the present disclosure, since the event occurrence notification is transmitted using the extension area 41d of the layer 2 communication protocol, it is possible to quickly start imaging with the camera terminals C3, C5, and C8 immediately after the occurrence of the event. Thus, according to the present disclosure, even in a case where a monitoring target moves at a high speed, it is possible to quickly start capturing video data from many angles immediately after the occurrence of the event. Further, since an instruction is not given to the unnecessary camera terminal 11C, it is possible to suppress power consumption of the camera terminal 11C in an unnecessary location when unnecessary.

In addition, in the present embodiment, an example in which an instruction from the management node 13 is the start of imaging has been described, but the present disclosure is not limited thereto. For example, in a case where the camera terminal 11C has already started imaging, an instruction of marker attachment may be given instead of the start of imaging. As a result, a marker can be added to the video data captured by the camera terminals C3, C5, and C8 illustrated in FIG. 5. As a result, it is possible to easily track a desired event from among the accumulated enormous video data.

Note that, in the present embodiment, the detection result of the human sensor terminal 11T is used as an imaging start trigger of the camera terminal 11C, but it is not limited to the human sensor terminal 11T, and it may be sensed that an object including a person or a thing approaches, or it may be the occurrence of any one or more events. For example, arbitrary metadata (strong impact, sound, change, or the like) that can be sensed by each terminal 11 may be used as an arbitrary trigger in an arbitrary sensor terminal.

### Other Embodiments

The terminal 11 and the management node 13 described above can also be implemented by a computer and a program, and the program can be recorded in a recording medium or provided through a network.

### Reference Signs List

11 Terminal
11T Human sensor terminal
11C Camera terminal
11a Sensor device
11b Sensing data storage processing unit
11c Device information storage processing unit
11d1, 11d2 Communication protocol operation unit
11e, 11e1, 11e2, 11e3, . . . Metadata detection unit
11f Metadata storage processing unit
11g Instruction interpretation unit
12 Network apparatus
12A Access point
13 Management node
13a Communication protocol operation unit
13b Information processing unit
13c Information storage unit
14 Upper management node
14a Data/metadata collection unit
14ba Position information calculation unit
14bc Instruction unit
14c Information storage unit
15 Data collection network
41 Frame
41a Logical identifier
41b Transmission source/destination identifier
41c Main data area
41d Extension area
301 to 302 Data collection system

1. A management node included in a data collection system that collects sensing data detected by a sub-sensor terminal and a main sensor terminal having different sensing targets in the management node,
wherein the management node is further configured to:
when receiving an event occurrence notification indicating that a sensing target is sensed by the sub-sensor terminal using an extension area of a layer 2 communication protocol, gives an instruction according to the event occurrence notification to the main sensor terminal.

2. The management node according to claim 1, wherein an operation defined by the instruction is start of sensing by the main sensor terminal.

3. The management node according to claim 1, wherein
the main sensor terminal is a camera terminal that captures an image of the sensing target, and
an operation defined by the instruction is attachment of a marker to captured video data.

4. A data collection system comprising:
a sub-sensor terminal that transmits an event occurrence notification using an extension area of a layer 2 communication protocol when sensing a sensing target of an own apparatus;
a management node that receives the event occurrence notification from the sub-sensor terminal; and
a main sensor terminal that executes an operation defined by an instruction from the management node.

5. The data collection system according to claim 4, wherein the main sensor terminal is activated from a sleep state when receiving an instruction from the management node.

6. The data collection system according to claim 4, wherein the sub-sensor terminal senses that an object including a person or a thing approaches a vicinity of the own apparatus.

7. A method executed by a management node included in a data collection system that collects sensing data detected by a sub-sensor terminal and a main sensor terminal having different sensing targets in the management node,
wherein the management node if further configured to:
when receiving an event occurrence notification indicating that a sensing target is sensed by the sub-sensor terminal using an extension area of a layer 2 communication protocol, gives an instruction according to the event occurrence notification to the main sensor terminal.

8. The method executed by the management node according to claim 7, wherein an operation defined by the instruction is start of sensing by the main sensor terminal.

9. The method executed by the management node according to claim 7, wherein
the main sensor terminal is a camera terminal that captures an image of the sensing target, and
an operation defined by the instruction is attachment of a marker to captured video data.

10. The management node according to claim 1, wherein the sensing data detected by the sensor device is stored in a region different from a region storing meta data in a frame.

11. The management node according to claim 10, wherein the sensing data is processed before storing into the frame by converting into a shortened code or into a plurality of multiple frames.

12. The management node according to claim 10, wherein the sensing data is stored at an arbitrarily timing.

13. The management node according to claim 12, wherein the sensing data is stored at a certain period of time after being accumulated.

14. The management node according to claim 1, wherein a frame transmission period is dynamically changed based on a decision made by the sub-sensor terminal and the main sensor terminal or based on an instruction from the management node.

15. The management node according to claim 1, wherein the management node is characterized by having a function of storing combinations of two or more pieces of collected information in an information storage.

16. The method executed by the management node according to claim 7, wherein the sensing data is stored in a region different from a region storing meta data in a frame.

17. The method executed by the management node according to claim 16, wherein the sensing data is processed before storing into the frame by converting into a shortened code or into a plurality of multiple frames.

18. The method executed by the management node according to claim 16, wherein the sensing data is stored at an arbitrarily timing.

19. The management node according to claim 16, wherein the sensing data is stored at a certain period of time after being accumulated.

20. The management node according to claim 7, wherein a frame transmission period is dynamically changed based on a decision made by the sub-sensor terminal and the main sensor terminal or based on an instruction from the management node.
